(19) United States
(12) Patent Application Publication
(10) Pub. No.: US 2015/0309205 A1
(43) Pub. Date: Oct. 29, 2015

(54) X-RAY TESTING SYSTEM, IN PARTICULAR MOBILE X-RAY TESTING SYSTEM FOR LARGE-VOLUME GOODS

(71) Applicant: SMITHS HEIMANN GMBH, Wiesbaden (DE)

(72) Inventor: Matthias CRASS, Griesheim (DE)

(73) Assignee: SMITHS HEIMANN GMBH, Wiesbaden (DE)

(21) Appl. No.: 14/650,179

(22) PCT Filed: Nov. 15, 2013
(86) PCT No.: PCT/EP2013/073962

§ 371 Date: Jun. 5, 2015

(30) Foreign Application Priority Data
Dec. 5, 2012 (DE) 10 2012 222 345.2

(51) Int. Cl. G01V 5/00

(52) U.S. Cl. CPC G01V 5/0066

(57) ABSTRACT

The invention relates to an x-ray testing system, in particular a mobile x-ray testing system for large-volume objects (5) to be tested, comprising at least one x-ray source, at least one detector arrangement (6), and a support arm (4) which extends downwards in a perpendicular manner and on which a detector arrangement (6) and/or an x-ray source is secured, an active vibration damper (8) being arranged on the support arm (4) for damping horizontal vibrations.

The invention relates to an X-ray testing system, in particular a mobile X-ray testing system for large-volume objects, comprising at least one X-ray source and at least one detector arrangement, wherein an X-ray source and/or a detector arrangement are mounted on a support arm, which extends downward at a right angle.

For monitoring containers and trucks for illicit goods, it is known that X-ray testing systems having at least one X-ray source for X-raying the container or the cargo space and a detector arrangement aimed at the X-ray source may be used.

As described in DE 195 32 965 A1, the system is designed to be in the shape of an archway where the archway is bordered by a support arm extending downward at a right angle with a detector arrangement fastened to it. For the inspection, the objects for inspection are either moved through the archway or the archway is moved over the stationary object for inspection. X-Rays are emitted in the shape of a fan by one or more X-ray sources, penetrating through the objects for testing and being detected by a detector arrangement aimed at the respective X-ray source.

In the case of mobile, self-propelled X-ray testing systems, which are moved in relation to the object for the purpose of testing, vibrations of the support arm, which extends freely downward with the detector arrangement and/or X-ray source mounted on the support arm, result in image distortions. Efforts have therefore been undertaken to prevent vibration of the support arm by moving the mobile X-ray test system over the smoothest possible floor, for example. However, it has been found that vibrations are triggered in startup and deceleration of the X-ray testing system in particular, leading to an impaired image quality.

The object of the invention is therefore to provide an X-ray testing system with which X-ray images of an improved quality can be produced.

This object is achieved by the fact that the X-ray test system has a support arm, which extends downward and has a detector arrangement and/or an X-ray source, on which an active vibration damper is arranged for damping horizontal vibrations.

Due to these arrangements, horizontal vibrations which occur in movement of the support arm past the object for inspection are damped. Thus the X-ray testing system may be arranged on a vehicle that transports it to different sites for use as well as on a stationary large-volume test object such as a truck or a maritime container, for example.

The vibration damper preferably includes a sensor for detection of vibrations and an active component, which has a vibration-absorbing or vibration-damping effect, depending on the vibrations detected.

The active component preferably consists of a weight that can be moved hydraulically, pneumatically, by electric linear motor or by some other method to counteract vibrations.

The invention is explained in greater detail below on the basis of an exemplary embodiment, which is shown in simplified form.

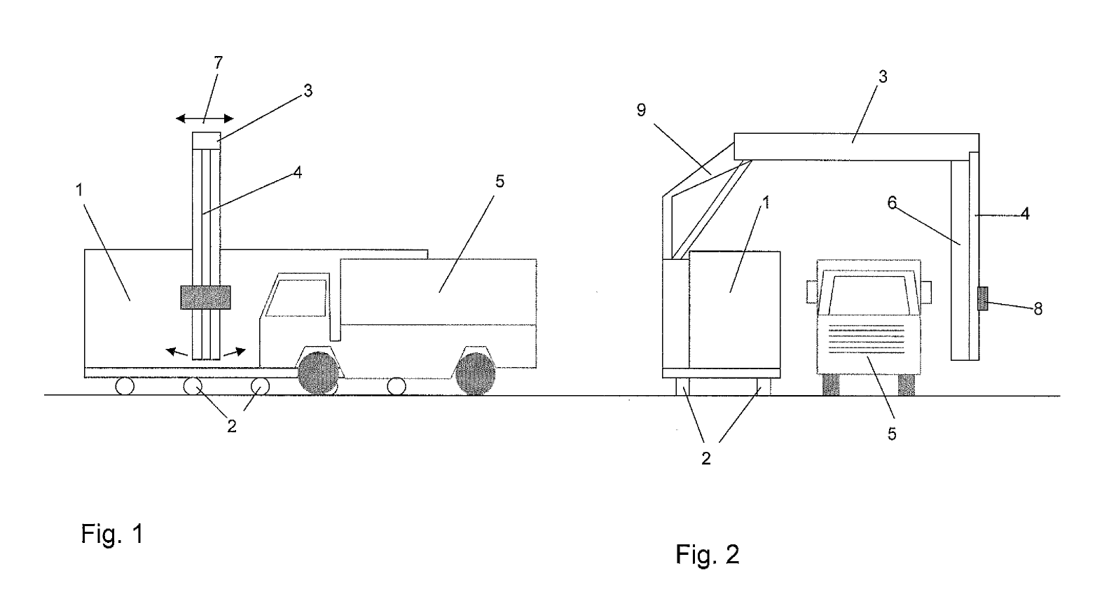

FIG. 1 shows in a roughly schematic diagram a mobile testing system for inspection of a truck,

FIG. 2 shows a view from the front.

FIG. 1 shows a mobile X-ray testing system for large-volume test objects. The testing system consists of a container-type housing 1, which is supported so that it can be moved back and forth on a vehicle with wheels 2. A crossbar 3 is mounted on the housing 1 by means of a rod 9 at a sufficient height, with a support arm 4, which extends downward on its free end and stops at a distance from the floor. The arms 3, 4 together with the housing 1 form an archway, whose free cross section is large enough so that it can be moved over a large-volume object, such as a truck 5, for inspection.

A row of detectors 6 is arranged on the inside of the perpendicular support arm 4. The respective X-ray source is situated inside the housing 1 and emits X-rays in the form of a perpendicular fan through a gap in the exterior wall in the direction of the detector arrangement 6. The beam path of the X-rays is selected so that the freight space of the truck 5 is scanned while the test system 1 is being moved back and forth relative to the truck 5 in the direction of the arrows 7.

An active vibration damper 8, which serves to dampen vibrations occurring during startup and shutdown of the X-ray testing system in particular, is mounted on the end of the support arm 4.

The vibration damper 8 has a sensor for detecting vibrations and has an active component, which acts to suppress or dampen the vibrations, depending on the vibration detected. The active component is preferably a weight that can be moved in the direction of the vibration amplitude, is moved in a phase-shifted manner to counteract the unwanted vibrations. The movement of the weight is accomplished hydraulically, pneumatically, by electric linear motor or by some other method.

1. An X-ray testing system in particular mobile X-ray testing system for large-volume test objects, having at least one X-ray source and at least one detector arrangement and having a support arm which extends downward at a right angle and on which a detector arrangement and/or an X-ray source is/are mounted, wherein an active vibration damper for damping horizontal vibrations is mounted on the support arm.

2. The X-ray testing system according to claim 1, wherein the support arm is designed to be movable past an object for inspection.

3. The X-ray testing system according to claim 2, wherein it is arranged on a motor vehicle and can be moved past the test object.

4. The X-ray testing system according to claim 1, wherein the vibration damper includes a sensor for detection of vibrations and an active component which acts to suppress vibration or dampen vibration depending on the vibrations detected.

5. The X-ray testing system according to claim 4, wherein the active component includes a weight that can be moved hydraulically, pneumatically, by electric linear motor or by some other means to counteract vibrations.
